(19) United States
(12) Patent Application Publication
(10) Pub. No.: US 2022/0253665 A1
(43) Pub. Date: Aug. 11, 2022

(54) RFID TAG ROLL

(71) Applicant: Murata Manufacturing Co., Ltd., Nagaokakyo-shi (JP)

(72) Inventor: Noriyuki UEKI, Nagaokakyo-shi (JP)

(21) Appl. No.: 17/656,436

(22) Filed: Mar. 25, 2022

Related U.S. Application Data
(63) Continuation of application No. PCT/JP2020/031305, filed on Aug. 19, 2020.

(30) Foreign Application Priority Data
Dec. 25, 2019 (JP) 2019-233792

(51) Int. Cl. G06K 19/077; H01Q 1/22

(52) U.S. Cl. CPC G06K 19/07773; H01Q 1/2283

(57) ABSTRACT

An RFID tag roll is configured such that a film or paper where a plurality of RFID tags are arranged is wound into a roll-like shape. Each of the RFID tags includes an antenna, and an RFIC module mounted to the antenna. The RFIC module includes a module base material, an RFIC mounted to this module base material, and a matching circuit. The antenna includes an antenna base material, and a radiation conductor provided at the antenna base material. The RFIC module is mounted to the antenna, and the RFIC is connected or coupled to the radiation conductor through the matching circuit. A direction in which the plurality of RFIC terminal electrodes are disposed side by side is perpendicular to a winding direction of the RFID tag roll.

### CROSS REFERENCE TO RELATED APPLICATIONS

The present application is a continuation of PCT/JP2020/031305 filed Aug. 19, 2020, which claims priority to Japanese Patent Application No. 2019-233792, filed Dec. 25, 2019, the entire contents of each of which are incorporated herein by reference.

### TECHNICAL FIELD

The present disclosure relates to an RFID (Radio Frequency IDentifier) tag including an RFIC (Radio Frequency Integrated Circuit) or an RFIC module, and particularly relates to an RFID tag roll to be wound into a roll-like shape.

### BACKGROUND

International Publication No. 2016/084658 (hereinafter “Patent Literature 1”) discloses an RFIC module to be coupled to a conductor that serves as an antenna. This RFIC module includes a substrate, an RFIC chip mounted to this substrate, and a matching circuit with a plurality of coils configured to be connected to this RFIC chip.

As with an RFID tag disclosed in Patent Literature 1, in a case in which an RFID tag configured by an antenna and an RFIC module mounted to the antenna is manufactured, a film or paper wound into a roll-like shape is used. For example, in a process of rewinding the film or paper wound into a roll-like shape, that is, in a roll-to-roll process, a large number of RFID tags are continuously formed on a resin film or paper. In such a manner, when a large number of RFID tags are manufactured in the roll-to-roll process, productivity improves. In addition, the large number of RFID tags, in a case of being collectively stored and transported, are efficiently stored and transported in a rolled state, which enables lower cost and higher productivity.

In this configuration, the antenna of the RFID tag is provided on a base material having flexibility, so that the RFID tag is suitable to be in a roll-like form. However, since an RFIC mounted to an antenna base material and an RFIC in the RFIC module mounted to the antenna base material are hard, bending stress is easily applied to the RFIC when the RFID tag is rolled. Therefore, cracking of the RFIC can result due to stress during the rolling process.

### SUMMARY OF THE INVENTION

In view of the foregoing, exemplary embodiments of the present invention provide an RFID tag roll that resolves concerns about cracking of an RFIC by reducing bending stress to the RFIC mounted to an RFID tag when a large number of RFID tags are wound into a roll-like shape.

In an exemplary aspect, an RFID tag roll is obtained by winding a film or paper where a plurality of RFID tags are arranged, into a roll-like shape, and each of the plurality of RFID tags is configured by an antenna and an RFIC mounted to the antenna. In this aspect, the antenna includes an antenna base material and a radiation conductor provided at the antenna base material, the RFIC includes a plurality of RFIC terminal electrodes that are connected to the antenna, and a direction in which the plurality of RFIC terminal electrodes are disposed side by side is perpendicular to a winding direction of the roll.

In addition, an RFID tag roll according to an exemplary embodiment of the present invention is obtained by winding a sheet where a plurality of RFID tags are arranged, into a roll-like shape, and each of the plurality of RFID tags is configured by an antenna and an RFIC module mounted to the antenna. In this aspect, the RFIC module includes a module base material, an RFIC mounted to the module base material, and a matching circuit provided at the module base material and performing matching with the RFIC. Moreover, the antenna includes an antenna base material, and a radiation conductor provided at the antenna base material. The RFIC module is mounted to the antenna, the RFIC is connected or coupled to the radiation conductor through the matching circuit, the RFIC includes a plurality of RFIC terminal electrodes, and a direction in which the plurality of RFIC terminal electrodes are disposed side by side is perpendicular to a winding direction of the roll.

In the exemplary aspects of the above structures, when a large number of RFID tags are wound into to a roll-like shape, bending stress to an RFIC mounted on the RFID tag is significantly reduced or prevented compared with conventional designs.

According to the exemplary aspects of the present invention, an RFID tag roll is provided that resolves concerns about cracking of an RFIC by reducing bending stress to the RFIC mounted to an RFID tag when a large number of RFID tags are wound into a roll-like shape.

### BRIEF DESCRIPTION OF DRAWINGS

FIG. 1A is a partial plan view in a state in which an RFID tag roll according to a first exemplary embodiment is spread. FIG. 1B is a front view of an RFID tag roll 301 according to the first exemplary embodiment.

FIG. 2A is a plan view of an RFID tag 201 according to the first exemplary embodiment. FIG. 2B is an enlarged plan view of a portion on which an RFIC module 101 included in the RFID tag 201 is mounted.

FIG. 3 is an enlarged plan view of the RFIC module 101.

FIG. 4A is a vertical cross-sectional view of the RFIC module 101 taken along a line X-X in FIG. 2B, and FIG. 4B is a vertical cross-sectional view of the RFIC module 101 taken along a line Y-Y in FIG. 2B.

FIG. 5 is a plan view showing a conductor pattern provided on a module base material 1 of the RFIC module 101.

FIG. 6 is a circuit diagram of the RFIC module 101.

FIG. 7A is a cross-sectional view taken along the line Y-Y in FIG. 2B, and FIG. 7B is a cross-sectional view taken along the line X-X in FIG. 2B.

FIG. 8 is a partial plan view in a state in which a resin film 60M of another RFID tag roll according to the first exemplary embodiment is spread.

FIG. 9 is a partial plan view in a state in which an RFID tag roll according to a second exemplary embodiment is spread.

FIG. 10A is a plan view of an RFID tag 202 according to the second exemplary embodiment. FIG. 10B is an enlarged plan view of a portion on which an RFIC module 102 included in the RFID tag 202 is mounted.

FIG. 11A is a plan view of an RFID tag 203 according to a third exemplary embodiment. FIG. 11B is an enlarged plan view of a portion on which an RFIC 2 included in the RFID tag 203 is mounted.

FIG. 12A is a cross-sectional view taken along a line Y-Y in FIG. 11B, and FIG. 12B is a cross-sectional view taken along a line X-X in FIG. 11B.

### DETAILED DESCRIPTION OF EXEMPLARY EMBODIMENTS

### First Exemplary Embodiment

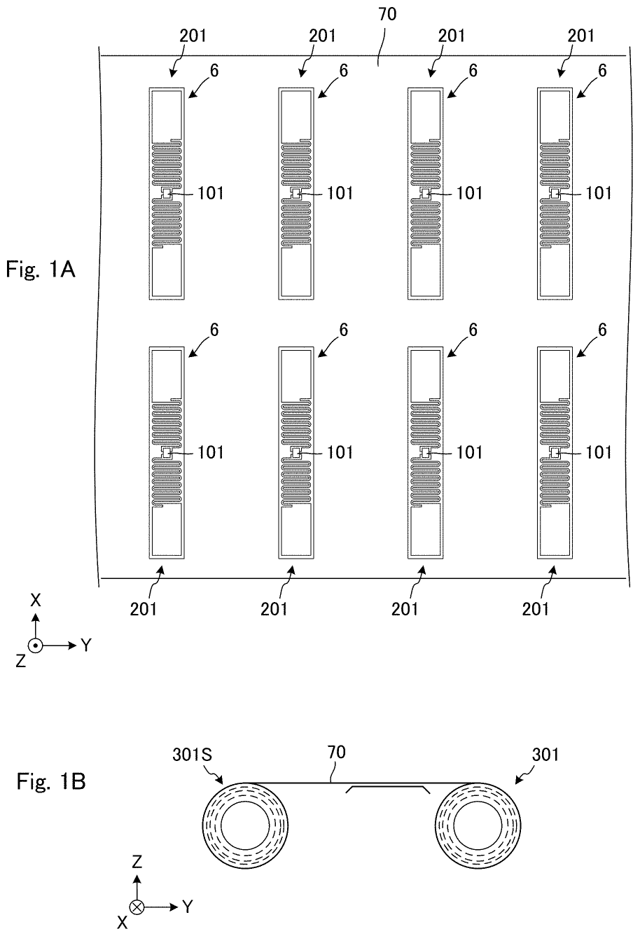

FIG. 1A is a partial plan view in a state in which an RFID tag roll according to a first exemplary embodiment is spread. FIG. 1B is a front view of an RFID tag roll 301 according to the first exemplary embodiment.

According to the exemplary aspect, the RFID tag roll 301, as shown in FIG. 1A, is configured by a large number of RFID tags 201 (e.g., a plurality of RFID tags) attached to a surface of strip-shaped paper 70. When this RFID tag roll 301 is manufactured, as shown in FIG. 1B, on the way to rewinding the paper from a roll 301S at a stage prior to mounting of an RFIC module, an RFIC module 101 is mounted in the antenna 6, and the paper is rolled into the RFID tag roll 301. Therefore, when expressed with the coordinate axes in the present embodiment, the winding direction (i.e., the length direction) of the RFID tag roll 301 is a Y direction as shown in FIG. 1B.

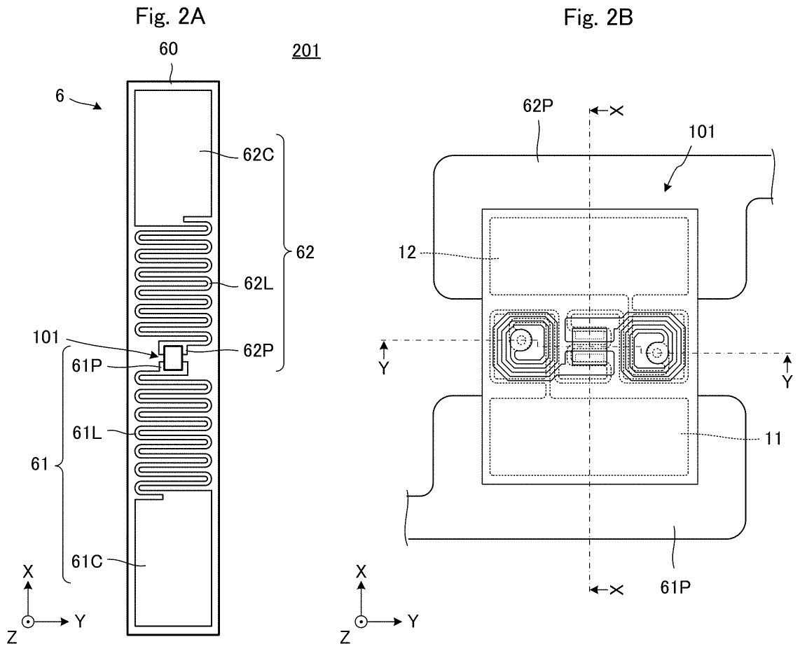

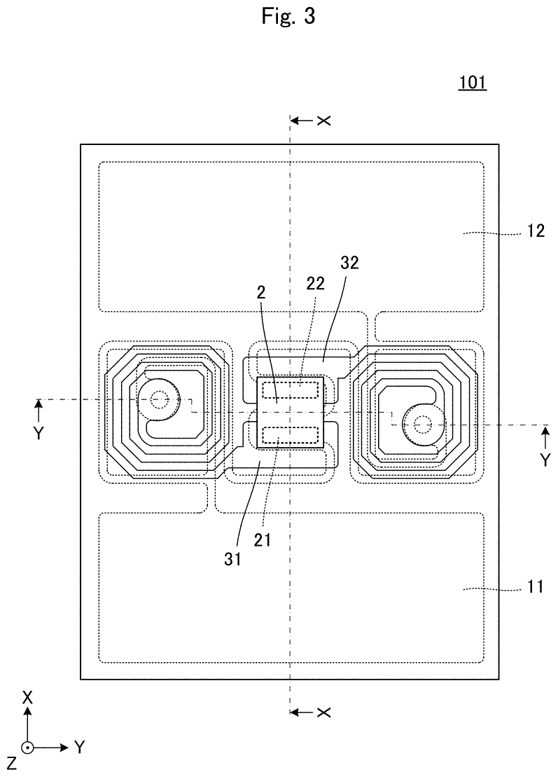

FIG. 2A is a plan view of an RFID tag 201 according to the first exemplary embodiment. FIG. 2B is an enlarged plan view of a portion on which an RFIC module 101 included in the RFID tag 201 is mounted. FIG. 3 is an enlarged plan view of the RFIC module 101.

The RFID tag 201 is configured by an antenna 6, and an RFIC module 101 coupled to the antenna 6. The antenna 6 is configured by an antenna base material 60 of an insulating film, and radiation conductors 61 and 62 provided on this antenna base material 60. According to an exemplary aspect, the antenna base material 60 is, for example, a polyethylene terephthalate (PET) film, and the radiation conductors 61 and 62 are, for example, patterns of aluminum foil.

The radiation conductor 61 is configured by conductor patterns 61P, 61L, and 61C, and the radiation conductor 62 is similarly configured by conductor patterns 62P, 62L, and 62C. The radiation conductors 61 and 62 configure a dipole antenna.

The RFIC module 101 is mounted on the conductor patterns 61P and 62P. The conductor patterns 61L and 62L have a meander line shape, and serve as a region having a high inductance component. In addition, the conductor patterns 61C and 62C have a planar shape and serve as a region having a high capacitance component. With this configuration, an inductance component in a high current intensity region is increased and a capacitance component in a high voltage intensity region is increased, which reduces a region in which the radiation conductors 61 and 62 of the antenna are provided.

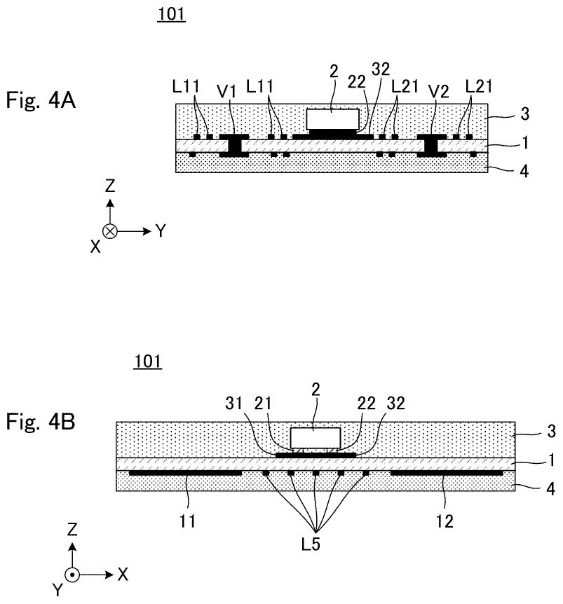

FIG. 4A is a vertical cross-sectional view of the RFIC module 101 taken along a line X-X in FIG. 2B, and FIG. 4B is a vertical cross-sectional view of the RFIC module 101 taken along a line Y-Y in FIG. 2B. As shown, the RFIC module 101 includes a module base material 1, and an RFIC 2 mounted on the module base material 1. The module base material 1 is, for example, a flexible substrate including polyimide or the like. The upper surface of the module base material 1 on which the RFIC 2 is mounted is covered with a protective film 3. This protective film 3 includes, for example, a hot melt agent such as elastomer such as polyurethane, and ethylene vinyl acetate (EVA). The lower surface of the module base material 1 is provided with a coverlay film 4. The coverlay film 4 is, for example, a polyimide film. Therefore, all of the module base material 1, the protective film 3, and the coverlay film 4 are flexible, and thus the RFIC module 101 as a whole has flexibility.

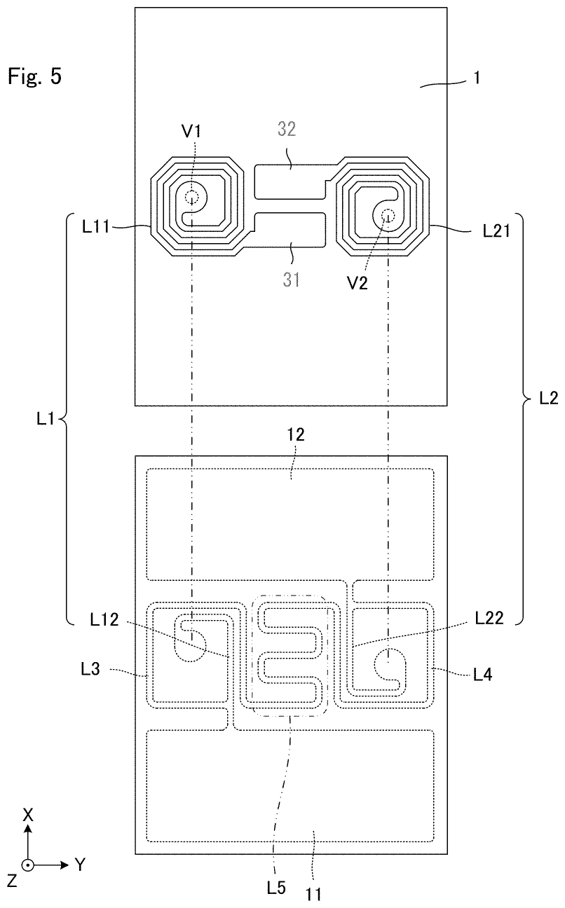

FIG. 5 is a plan view showing a conductor pattern provided on the module base material 1 of the RFIC module 101. An upper part of FIG. 5 is a plan view of conductor patterns provided on the upper surface of the module base material 1, and a lower part of FIG. 5 is a plan view of conductor patterns provided on the lower surface of the module base material 1.

As shown, the upper surface of the module base material 1 is provided with an RFIC side first terminal electrode 31, an RFIC side second terminal electrode 32, a conductor pattern L11 that is a main part of a first inductor L1, and a conductor pattern L21 that is a main part of a second inductor L2. The RFIC side first terminal electrode 31 is connected to a first end of the conductor pattern L11, and the RFIC side second terminal electrode 32 is connected to a first end of the conductor pattern L21. These conductor patterns are, for example, obtained by patterning copper foil by photolithography.

Moreover, the lower surface of the module base material 1 is provided with a module first terminal electrode and a module second terminal electrode 12 that are capacitively coupled to the conductor patterns 61P and 62P of the antenna 6. In addition, the lower surface of the module base material 1 is provided with a conductor pattern L12 that is a part of the first inductor L1, a conductor pattern L22 that is a part of the second inductor, a conductor pattern of a third inductor L3, a conductor pattern of a fourth inductor L4, and a conductor pattern (i.e., a conductor pattern surrounded by a chain double-dashed line) of a fifth inductor L5. These conductor patterns are, for example, also obtained by patterning copper foil by photolithography.

A first end of the conductor pattern L12 that is a part of the first inductor L1 and a first end of the conductor pattern of the third inductor L3 are connected to the module first terminal electrode 11. Similarly, a first end of the conductor pattern L22 that is a part of the second inductor L2 and a first end of the conductor pattern of the fourth inductor L4 are connected to the module second terminal electrode 12. The conductor pattern of the fifth inductor L5 is connected between a second end of the conductor pattern of the third inductor L3 and a second end of the conductor pattern of the fourth inductor L4.

A second end of the conductor pattern of the third inductor L3 and a second end of the conductor pattern L11 of the main part of the first inductor L1 are connected to each other through a via conductor V1. Similarly, a second end of the conductor pattern of the fourth inductor L4 and a second end of the conductor pattern L21 of the main part of the second inductor L2 are connected to each other through a via conductor V2.

The RFIC 2 is mounted on the RFIC side first terminal electrode 31 and the RFIC side second terminal electrode 32. In other words, an RFIC terminal electrode 21 of the RFIC 2 is connected to the RFIC side first terminal electrode 31, and an RFIC terminal electrode 22 of the RFIC 2 is connected to the RFIC side second terminal electrode 32 as shown in FIG. 4B, for example.

The first inductor L1 and the third inductor L3 are respectively provided on different layers of the module base material 1, and are disposed in such a relationship as to have coil openings overlapping each other. Similarly, the second inductor L2 and the fourth inductor L4 are respectively provided on different layers of the module base material 1, and are disposed in such a relationship as to have coil openings overlapping each other. The second inductor L2 and the fourth inductor L4, and the first inductor L1 and the third inductor L3 are disposed in such a positional relationship as to interpose a mounting position of the RFIC 2 along the surface of the module base material 1.

Furthermore, the winding direction from the RFIC side first terminal electrode 31 to a second end of the third inductor L3 is the same as the winding direction from the RFIC side second terminal electrode 32 to a second end of the fourth inductor L4. The directions shown in FIG. 3 and FIG. 5 are both in the clockwise direction. Thus, a set of the first inductor L1 and the third inductor L3 and a set of the second inductor L2 and the fourth inductor L4 are able to be regarded as being in a 180° rotational symmetry relationship while interposing the mounting position of the RFIC 2.

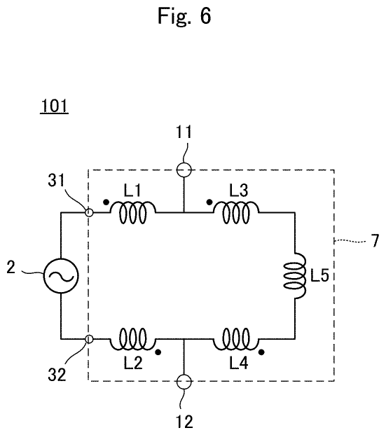

FIG. 6 is a circuit diagram of the RFIC module 101. As shown, the RFIC module 101 is configured by the RFIC 2 and an impedance matching circuit 7. The impedance matching circuit 7 is connected to the RFIC side first terminal electrode 31, the RFIC side second terminal electrode 32, the module terminal electrodes 11 and 12. In addition, the impedance matching circuit 7 is configured to include the first inductor L1, the second inductor L2, the third inductor L3, the fourth inductor L4, and the fifth inductor L5.

The first inductor L1 is configured by the conductor patterns L11 and L12 illustrated in FIG. 5, and the second inductor L2 is configured by the conductor patterns L21 and L22 illustrated in FIG. 5. The first inductor L1 is connected between the module first terminal electrode 11 and the RFIC side first terminal electrode 31. The second inductor L2 is connected between the module second terminal electrode 12 and the RFIC side second terminal electrode 32. A first end of the third inductor L3 is connected to the module first terminal electrode 11, a first end of the fourth inductor L4 is connected to the module second terminal electrode 12, and the fifth inductor L5 is connected between the second end of the third inductor L3 and the second end of the fourth inductor L4.

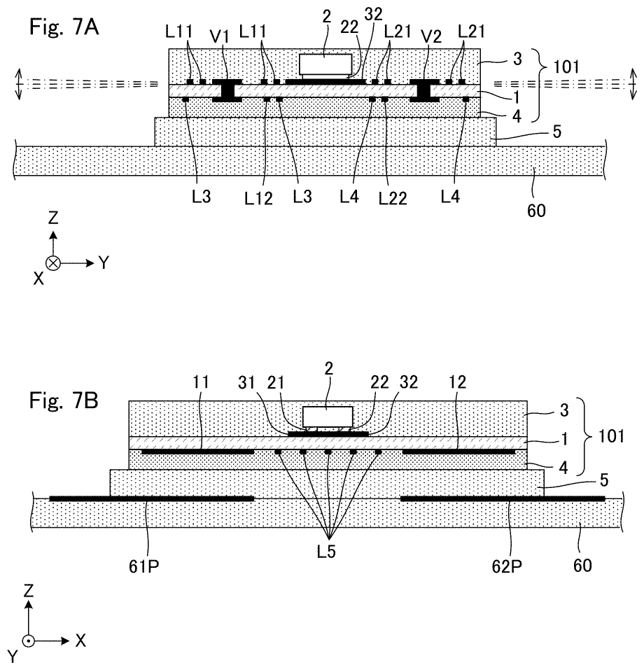

Herein, a cross-sectional structure of the mounting position of the RFIC module 101 with respect to the antenna 6 in the RFID tag 201 will be described. FIG. 7A is a cross-sectional view taken along the line Y-Y in FIG. 2B, and FIG. 7B is a cross-sectional view taken along the line X-X in FIG. 2B. As shown in FIG. 7A and FIG. 7B, the RFIC module 101 is adhered (or otherwise coupled) to the antenna base material 60 of the antenna 6 through an adhesive layer 5. This adhesive layer 5 is a layer of an insulating adhesive material such as an acrylic adhesive agent, for example. The module first terminal electrode 11 faces the conductor pattern 61P of the antenna 6 through the coverlay film 4 and the adhesive layer 5, and the module second terminal electrode 12 faces the conductor pattern 62P of the antenna 6 through the coverlay film 4 and the adhesive layer 5. With this structure, the module first terminal electrode 11 and the module second terminal electrode 12 are respectively capacitively coupled to the conductor patterns 61P and 62P of the antenna 6.

Referring back to FIG. 1A and FIG. 1B, since the winding direction (i.e., the length direction) of the RFID tag roll 301 is the Y direction, bending stress in a Y-Z plane is generated in the RFIC module 101 when the RFIC module 101 is mounted on the antenna base material 60, and is being rolled into and is rolled up to the RFID tag roll 301. A dashed-dotted line in FIG. 7A conceptually shows the bending stress.

In the RFIC terminal electrodes 21 and 22 of the RFIC 2, a metal layer such as Cr, Cu, and Sn is provided on an Al pad, and a solder bump is further provided on the surface of the metal layer. Therefore, areas in which the RFIC terminal electrodes 21 and 22 are provided are more rigid than other areas.

As shown in FIG. 2B and FIG. 7B, the RFIC terminal electrodes 21 and 22 of the RFIC 2 are disposed side by side in a direction (i.e., an X direction) perpendicular to the Y direction being the winding direction of the RFID tag roll 301. Therefore, the RFIC 2 is more resistant to the bending stress in a Y-Z plane than to the bending stress in an X-Z plane. According to the present exemplary embodiment, a direction in which the RFIC 2 has high resistance to the bending stress is the winding direction (i.e., the Y direction) of the RFID tag roll 301, so that an RFID tag roll is provided that resolves concerns about cracking of the RFIC 2.

In addition, in the present exemplary embodiment, as mainly shown in FIG. 3, the module base material 1 has a rectangular plate shape with the X direction as a long side and the Y direction as a short side. Therefore, the rigidity of the module base material 1 to bending in the Y-Z plane is higher than the rigidity of the module substrate 1 to bending in the X-Z plane. Then, the short side coincides with the Y direction being the winding direction of the RFID tag roll 301, so that this module base material 1 more effectively relaxes the bending stress to the RFIC 2 in the Y direction. With such a function, the RFID tag roll resolves concerns about cracking of the RFIC 2.

In addition, in the present exemplary embodiment, the RFIC terminal electrodes 21 and 22 have a rectangular shape with the Y direction being the winding direction of the RFID tag roll 301 as a longitudinal direction. The rigidity of these RFIC terminal electrodes 21 and 22 to the bending in the Y-Z plane is higher than the rigidity of the RFIC terminal electrodes 21 and 22 to the bending in the X-Z plane. That is, the RFIC terminal electrodes 21 and 22 more effectively relax the bending stress to the RFIC 2 in the Y direction. With such a function, the RFID tag roll resolves concerns about cracking of the RFIC 2.

In addition, in the present exemplary embodiment, the RFIC module 101 has the module terminal electrodes 11 and 12, and the module terminal electrodes 11 and 12 have a rectangular shape with the winding direction (i.e., the Y direction) of a roll as a longitudinal direction. The rigidity of these module terminal electrodes 11 and 12 to the bending in the Y-Z plane is higher than the rigidity of the module terminal electrodes 11 and 12 to the bending in the X-Z plane. That is, the module terminal electrodes 11 and 12 more effectively relax the bending stress to the RFIC 2 in the Y direction. With such a function, the RFID tag roll in which concerns about cracking of the RFIC 2 have been further resolved is obtained.

In addition, in the present exemplary embodiment, the radiation conductors 61 and 62 have the meander line shaped conductor patterns 61L and 62L, and a runout direction of the meander line is the Y direction being the winding direction of a roll as shown in FIG. 1A, for example. The rigidity of these meander line shaped conductor patterns 61L and 62L to the bending in the Y-Z plane is higher than the rigidity of the meander line shaped conductor patterns 61L and 62L to the bending in the X-Z plane. That is, the meander line shaped conductor patterns 61L and 62L more effectively relax the bending stress to the RFIC 2 in the Y direction. With such a function, the RFID tag roll resolves concerns about cracking of the RFIC 2.

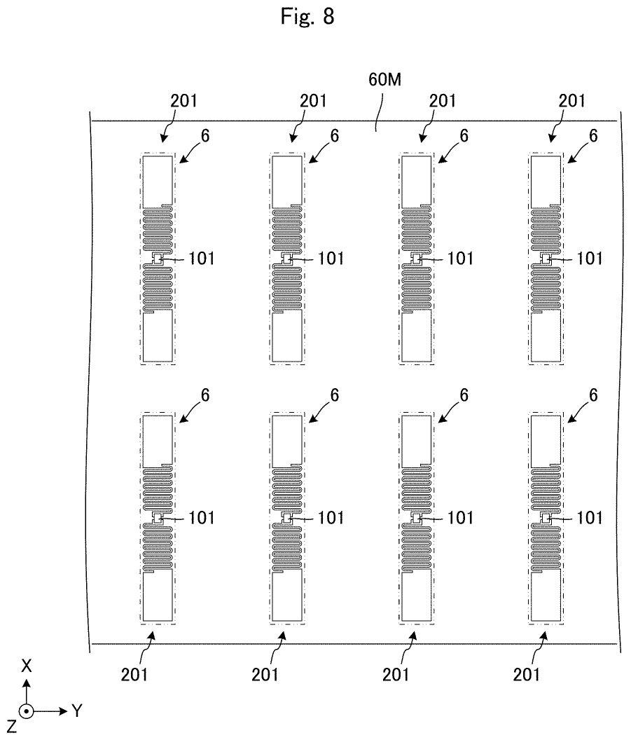

It is to be noted that, while, in an example shown in FIG. 1A, the example in which the RFID tags 201 are attached to a surface of the strip-shaped paper 70 is shown, the RFID tags 201 may be directly formed on a resin film 60M such as a polyethylene terephthalate (PET) film, for example. FIG. 8 is a partial plan view in a state in which the resin film 60M of another RFID tag roll according to the first exemplary embodiment is spread. In an example shown in FIG. 8, the RFID tags 201 each are formed at a plurality of positions surrounded by a chain double-dashed line, and rolled up as an RFID tag roll. Subsequently, when necessary, a portion surrounded by a chain double-dashed line is punched out from the resin film 60M, so that the RFID tags 201 are separated from the resin film 60M. In the RFID tag roll of such a structure as well, the same advantageous functions and effects are obtained.

### Second Exemplary Embodiment

In a second exemplary embodiment of the present disclosure, an example in which a relationship between a longitudinal direction of an RFID tag and an terminal electrode of an RFIC is different from the relationship in the first exemplary embodiment will be described.

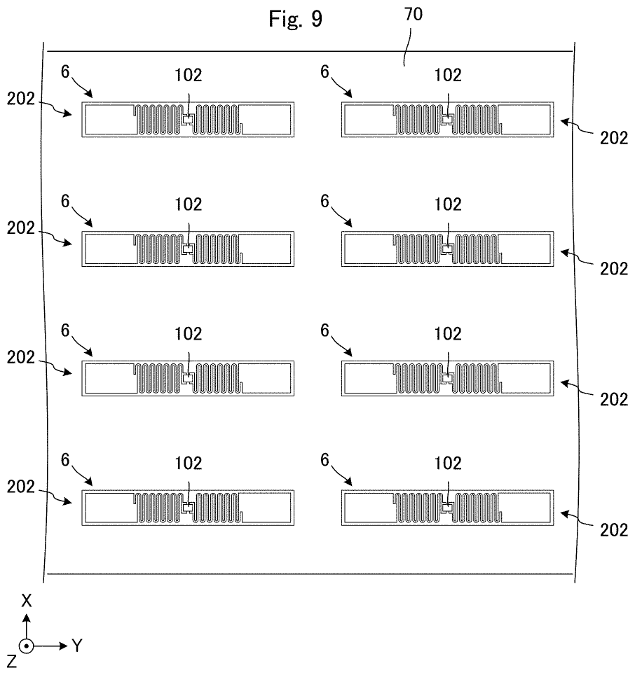

FIG. 9 is a partial plan view in a state in which an RFID tag roll according to the second exemplary embodiment is spread. This RFID tag roll includes a large number of RFID tags 202 (e.g., a plurality of RFID tags) attached to a surface of strip-shaped paper 70. The winding direction (i.e., the length direction) of this RFID tag roll is the Y direction.

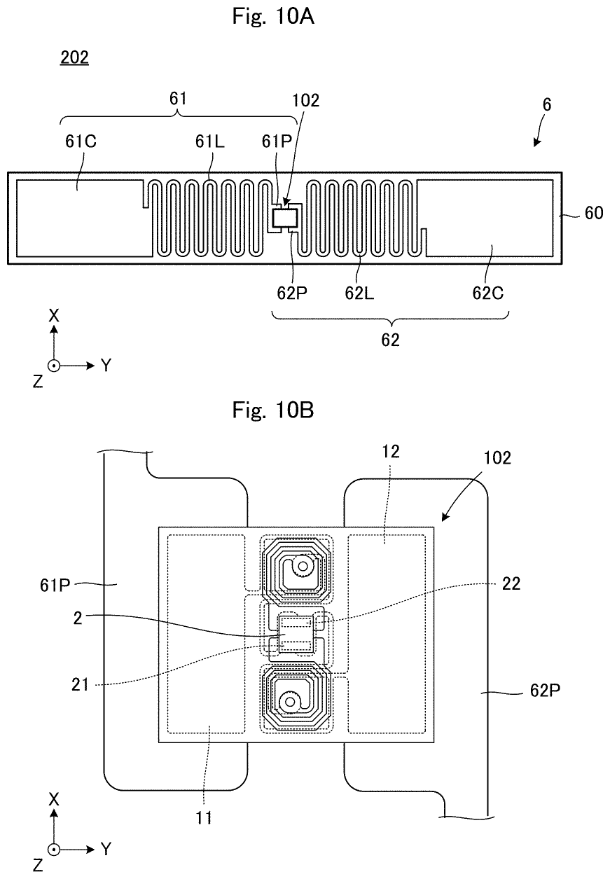

FIG. 10A is a plan view of an RFID tag 202 according to the second exemplary embodiment. FIG. 10B is an enlarged plan view of a portion on which an RFIC module 102 included in the RFID tag 202 is mounted.

The RFID tag 202 is configured by an antenna 6, and an RFIC module 102 coupled to the antenna 6. The antenna 6 is configured by an antenna base material 60, and radiation conductors 61 and 62 provided on this antenna base material 60. The antenna base material 60 is, for example, a polyethylene terephthalate (PET) film, and the radiation conductors 61 and 62 are, for example, patterns of aluminum foil.

A direction in which the RFID tag 202 is attached to the strip-shaped paper 70 is different by 90° from the direction in the examples shown in FIG. 2A and FIG. 2B in the first exemplary embodiment. In addition, a direction in which the RFIC terminal electrodes 21 and 22 of the RFIC 2 are disposed side by side with respect to the antenna base material 60 of the antenna 6 is different by 90°. Other configurations are the same as the configurations described in the first exemplary embodiment and will not be repeated herein.

In the second exemplary embodiment as well, as shown in the first exemplary embodiment, the direction in which the RFIC terminal electrodes 21 and 22 are disposed side by side is the X direction, and is perpendicular to the winding direction (i.e., the Y direction) of the RFID tag roll.

According to the present exemplary embodiment, the direction in which the RFIC 2 has high resistance to the bending stress is the winding direction of the RFID tag roll 301, so that an RFID tag roll resolves concerns about cracking of the RFIC 2.

### Third Exemplary Embodiment

In a third exemplary embodiment, an example of an RFID tag roll in which RFID tags configured by an antenna and an RFIC mounted to the antenna are arranged will be described.

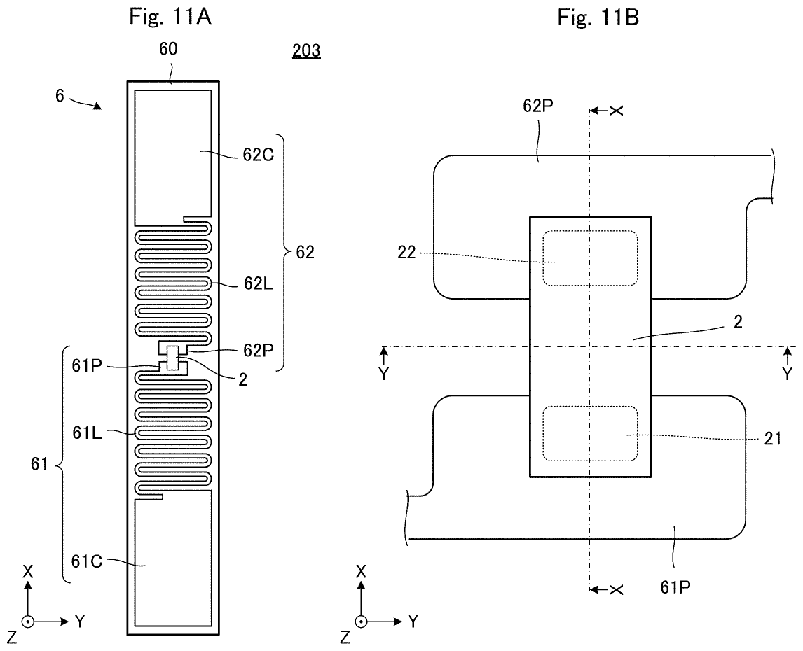

FIG. 11A is a plan view of an RFID tag 203 according to the third exemplary embodiment. FIG. 11B is an enlarged plan view of a portion on which an RFIC 2 included in the RFID tag 203 is mounted.

The RFID tag 203 is configured by an antenna 6, and an RFIC 2 connected to the antenna 6. The antenna 6 is configured by an antenna base material 60, and radiation conductors 61 and 62 provided on this antenna base material 60. Moreover, the antenna base material 60 is, for example, a polyethylene terephthalate (PET) film, and the radiation conductors 61 and 62 are, for example, patterns of Cu foil.

The radiation conductor 61 is configured by conductor patterns 61P, 61L, and 61C, and the radiation conductor 62 is similarly configured by conductor patterns 62P, 62L, and 62C. The radiation conductors 61 and 62 configure a dipole antenna.

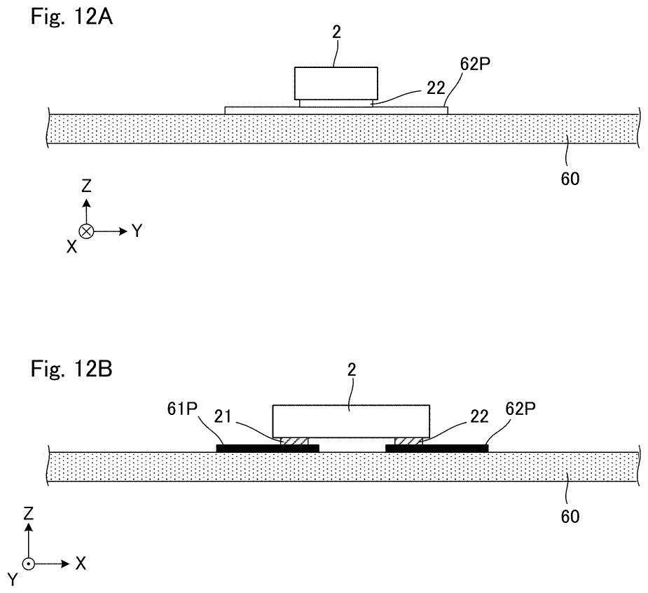

FIG. 12A is a cross-sectional view taken along a line Y-Y in FIG. 11B, and FIG. 12B is a cross-sectional view taken along a line X-X in FIG. 11B. Unlike the example shown in FIG. 2A and FIG. 2B in the first exemplary embodiment, the RFIC 2 is directly and electrically connected to the conductor patterns 61P and 62P.

As described above, the areas in which the RFIC terminal electrodes 21 and 22 are provided are more rigid than other areas. As shown in FIG. 11B and FIG. 12B, the RFIC terminal electrodes 21 and 22 of the RFIC 2 are disposed side by side in the direction (i.e., the X direction) perpendicular to the Y direction being the winding direction of the RFID tag roll. Therefore, the RFIC 2 is more resistant to the bending stress in the Y-Z plane than to the bending stress in the X-Z plane. According to the present exemplary embodiment, the direction in which the RFIC 2 has high resistance to the bending stress is the winding direction of the RFID tag roll 301, so that an RFID tag roll again resolves concerns about cracking of the RFIC 2.

In addition, in the present exemplary embodiment, the RFIC 2 has a rectangular plate shape with a long side and a short side, and the short side coincides with the Y direction being the winding direction of the RFID tag roll. Therefore, the rigidity of the RFIC 2 to the bending in the Y-Z plane is higher than the rigidity of the RFIC 2 to the bending in the X-Z plane. That is, the RFIC 2 is mounted in a direction in which the bending stress to the RFIC 2 in the Y direction is more effectively relaxed. With such a configuration, the RFID tag roll in which concerns about cracking of the RFIC 2 have been further resolved is obtained.

In addition, in the present exemplary embodiment, the RFIC terminal electrodes 21 and 22 have a rectangular shape with the Y direction being the winding direction of the RFID tag roll as a longitudinal direction. The rigidity of these RFIC terminal electrodes 21 and 22 to the bending in the Y-Z plane is higher than the rigidity of the RFIC terminal electrodes 21 and 22 to the bending in the X-Z plane. That is, the RFIC terminal electrodes 21 and 22 more effectively relax the bending stress to the RFIC 2 in the Y direction. With such a function, the RFID tag roll in which concerns about cracking of the RFIC 2 have been further resolved is obtained.

In addition, in the present exemplary embodiment, the radiation conductors 61 and 62 have the meander line shaped conductor patterns 61L and 62L, and a runout direction of the meander line is the Y direction being the winding direction of a roll. The rigidity of these meander line shaped conductor patterns 61L and 62L to the bending in the Y-Z plane is higher than the rigidity of the meander line shaped conductor patterns 61L and 62L to the bending in the X-Z plane. That is, the meander line shaped conductor patterns 61L and 62L more effectively relax the bending stress to the RFIC 2 in the Y direction. With such a function, the RFID tag roll resolves concerns about cracking of the RFIC 2.

Finally, it is noted generally that the above-described exemplary embodiments are to be considered in all respects as illustrative and not restrictive. Variations and modifications can be made as appropriate by those skilled in the art.

For example, in the example shown in FIG. 7B, the module first terminal electrode 11 and the conductor pattern 61P of the antenna are capacitively coupled and the module second terminal electrode 12 and the conductor pattern 62P of the antenna are capacitively coupled. However, this capacitive coupling portion can be directly (in a direct current manner) connected in an alternative exemplary aspect. Moreover, one can be directly connected and the other can be capacitively coupled in another variation of the exemplary aspect.

In addition, for example, the above example describes the roll of the RFID tag including the RFIC having two RFIC terminal electrodes. However, the present invention is also applicable to an RFID tag including an RFIC having three or more RFIC terminal electrodes.

### REFERENCE SIGNS LIST

L1—first inductor
L2—second inductor
L3—third inductor
L4—fourth inductor
L5—fifth inductor
L11, L12, L21, L22—conductor pattern
V1, V2—via conductor
1—module base material
2—RFIC
3—protective film
4—coverlay film
5—adhesive layer
6—antenna
7—impedance matching circuit
11—module first terminal electrode
12—module second terminal electrode
21, 22—RFIC terminal electrode
31—RFIC side first terminal electrode
32—RFIC side second terminal electrode
60—antenna base material
60M—resin film
61, 62—radiation conductor
61P, 61L, 61C—conductor pattern
62P, 62L, 62C—conductor pattern
70—paper
101, 102—RFIC module
201, 202, 203—RFID tag
301—RFID tag roll
301S—RFIC module pre-mounted roll

1. An RFID tag roll comprising:
a film or paper; and
a plurality of RFID tags that are each configured by an antenna and an RFIC mounted to the antenna,
wherein the plurality of RFID tags are arranged at the film or paper that is wound into a roll-like shape,
wherein the antenna includes an antenna base material, and a radiation conductor disposed at the antenna base material,
wherein the RFIC of each of the plurality of RFID tags includes a plurality of RFIC terminal electrodes that are connected to the antenna, respectively,
wherein a direction in which the plurality of RFIC terminal electrodes are disposed side by side is perpendicular to a winding direction of the RFID tag roll,
wherein the RFIC of each of the plurality of RFID tags has a rectangular plate shape with a long side and a short side that coincides with the winding direction of the RFID tag roll, and
wherein each of the plurality of RFIC terminal electrodes has a rectangular shape with the winding direction of the RFID tag roll as a longitudinal direction.

2. The RFID tag roll according to claim 1, wherein the radiation conductor of the antenna of each of the plurality of RFID tags has a meander line shaped portion.

3. The RFID tag roll according to claim 2, wherein a runout direction of the meander line shaped portion coincides with the winding direction of the RFID tag roll.

4. The RFID tag roll according to claim 3, wherein a rigidity of the meander line shaped portion to bending in a plane parallel to the winding direction is higher than a rigidity of the meander line shaped portion to bending in a direction orthogonal to the winding direction.

5. The RFID tag roll according to claim 1, wherein each of the plurality of RFID tags further comprises a protective film disposed on a first side of a module base material that covers the RFIC and a coverlay disposed on a second side of the module base material opposite the first side.

6. The RFID tag roll according to claim 1, wherein each of the plurality of RFID tags further comprises a pair of module terminal electrodes disposed on a lower surface of a module base material that are capacitively coupled to a pair of conductor patterns disposed on an upper surface of the antenna base material.

7. The RFID tag roll according to claim 5, wherein each of the plurality of RFID tags further comprises first and second inductors disposed on an upper surface of the module base material.

8. The RFID tag roll according to claim 7, wherein each of the plurality of RFID tags further comprises third and fourth inductors disposed on the lower surface of the module base material, with respective coil openings of the first and third inductors overlapping each other and respective coil openings of the second and fourth inductors overlapping each other.

9. The RFID tag roll according to claim 8, wherein a winding direction from a first terminal electrode of the plurality of RFIC terminal electrodes to an end of the third inductor is a same as a winding direction from a second terminal electrode of the plurality of RFIC terminal electrodes to an end of the fourth inductor.

10. The RFID tag roll according to claim 9, wherein a set of the first and third inductors and a set of the second and fourth inductors are configured to have a 180° rotational symmetry relationship with the RFIC interposed between the respective sets.

11. The RFID tag roll according to claim 1, wherein a rigidity of the plurality of RFIC terminal electrodes to bending in a plane parallel to the winding direction is higher than a rigidity of the plurality of RFIC terminal electrodes to bending in a direction orthogonal to the winding direction.

12. An RFID tag roll comprising:
a sheet; and
a plurality of RFID tags that are each configured by an antenna and an RFIC module mounted to the antenna,
wherein the plurality of RFID tags are arranged at the sheet that is wound into a roll-like shape,
wherein the RFIC module of each of the plurality of RFID tags includes a module base material, an RFIC mounted to the module base material, and a matching circuit disposed at the module base material and configured to perform matching with the RFIC,
wherein the antenna of each of the plurality of RFID tags includes an antenna base material, and a radiation conductor disposed at the antenna base material,
wherein the RFIC of each of the plurality of RFID tags is connected or coupled to the radiation conductor through the matching circuit and includes a plurality of RFIC terminal electrodes,
wherein a direction in which the plurality of RFIC terminal electrodes are disposed side by side is perpendicular to a winding direction of the RFID tag roll,
wherein the RFIC module of each of the plurality of RFID tags has a rectangular plate shape with a long side and a short side that coincides with the winding direction of the RFID tag roll, and
wherein the plurality of RFIC terminal electrodes each have a rectangular shape with the winding direction of the RFID tag roll as a longitudinal direction.

13. The RFID tag roll according to claim 12, wherein the module base material has a rectangular plate shape with a long side and a short side that coincides with the winding direction of the RFID tag roll.

14. The RFID tag roll according to claim 12, wherein each RFIC module includes a module terminal electrode having a rectangular shape with the winding direction of the RFID tag roll as a longitudinal direction.

15. The RFID tag roll according to claim 12,
wherein the radiation conductor has a meander line shaped portion, and
wherein a runout direction of the meander line shaped portion coincides with the winding direction of the RFID tag roll.

16. The RFID tag roll according to claim 15, wherein a rigidity of the meander line shaped portion to bending in a plane parallel to the winding direction is higher than a rigidity of the meander line shaped portion to bending in a direction orthogonal to the winding direction.

17. The RFID tag roll according to claim 14, wherein each RFIC module further comprises a pair of module terminal electrodes disposed on a lower surface of the module base material that are capacitively coupled to a pair of conductor patterns disposed on an upper surface of the antenna base material.

18. The RFID tag roll according to claim 12, wherein each RFIC module further comprises first and second inductors disposed on an upper surface of the module base material.

19. The RFID tag roll according to claim 18, wherein each RFIC module further comprises third and fourth inductors disposed on the lower surface of the module base material, with respective coil openings of the first and third inductors overlapping each other and respective coil openings of the second and fourth inductors overlapping each other.

20. The RFID tag roll according to claim 19, wherein a winding direction from a first terminal electrode of the plurality of RFIC terminal electrodes to an end of the third inductor is a same as a winding direction from a second terminal electrode of the plurality of RFIC terminal electrodes to an end of the fourth inductor.
